(19) United States
(12) Patent Application Publication
(10) Pub. No.: US 2025/0199256 A1
(43) Pub. Date: Jun. 19, 2025

(54) OPTICAL CHIP AND PREPARATION METHOD FOR OPTICAL CHIP

(71) Applicant: Wuhan VanJee Optoelectronic Technology Co., Ltd., Wuhan (CN)

(72) Inventors: Yang XU, Wuhan (CN); Yongqiang DENG, Wuhan (CN)

(73) Assignee: Wuhan VanJee Optoelectronic Technology Co., Ltd., Wuhan (CN)

(21) Appl. No.: 18/929,676

(22) Filed: Oct. 29, 2024

Related U.S. Application Data
(63) Continuation of application No. PCT/CN2023/139999, filed on Dec. 19, 2023.

(51) Int. Cl. G02B 6/42

(52) U.S. Cl. CPC G02B 6/4273; G02B 6/4267

(57) ABSTRACT

The present application discloses an optical chip and a preparation method for the optical chip. The optical chip includes a heat isolation substrate and an optical device structure layer formed based on a top silicon layer in an SOI substrate and located above the heat isolation substrate; where the heat isolation substrate is in a single-layer material structure or a laminated structure including a plurality of material layers, and the heat isolation substrate comprises at least one material layer formed of a material with a thermal conductivity less than 100 W/(m·K); the optical device structure layer sequentially from bottom to top includes: a protection layer; and a first optical device layer located on the protection layer and including at least one first optical device, where a light beam exiting through the optical device structure layer exits upward to a detection space.

### CROSS-REFERENCE TO RELATED APPLICATION

This application is a continuation of international PCT application serial no. PCT/CN2023/139999, filed on Dec. 19, 2023. The entirety of the above-mentioned patent application is hereby incorporated by reference herein and made a part of this specification.

### TECHNICAL FIELD

The present application belongs to the technical field of semiconductors, in particular, to an optical chip and a preparation method for the optical chip.

### BACKGROUND

At present, SOI (Silicon On Insulator) is usually used as a substrate for silicon optical chips, integrated optical devices are processed and fabricated on the top silicon, and after fabrication, a silicon dioxide layer is grown on the top to protect optical devices. However, the substrate silicon in the SOI substrate is usually about 700 μm (micron) in thickness, and even though the thickness may be thinned to about 400 μm by grinding and polishing, it is still 2 to 3 orders of magnitude different from the thickness of 220 nm of the top silicon and the thickness of 2 μm or 3 μm of the silicon dioxide layer in the SOI substrate. Silicon has a thermal conductivity of about 150 W/(m·K), and is a material with good thermal conductivity. If there are optical devices that generate heat in parts of the optical chip, heat may be quickly transmitted to the whole optical chip through the thick substrate silicon, resulting in serious thermal crosstalk.

In order to reduce thermal crosstalk, a TEC (Thermo Electric Cooler) is usually added at a bottom of an optical chip as a heat dissipation device in related art, which quickly dissipates the heat generated in the optical chip and reduces the internal heat accumulation. Although this solution can partially solve the problem of thermal crosstalk, the electrical power consumption of the TEC needs to be increased to a Watt level if a better result is to be obtained, and it is also difficult to dissipate the heat generated by the TEC. It can be seen that the optical chip in the related art has a problem of serious thermal crosstalk.

### SUMMARY

The embodiments of the present application provide an optical chip and a preparation method for the optical chip, to at least solve the problem of serious thermal crosstalk in optical chips in the related art.

According to one aspect of the embodiments of the present application, an optical chip is provided, including a heat isolation substrate and an optical device structure layer formed based on a top silicon layer in an SOI substrate and located above the heat isolation substrate; where the heat isolation substrate is in a single-layer material structure or a laminated structure including a plurality of material layers, and the heat isolation substrate includes at least one material layer formed of a material with a thermal conductivity less than 100 W/(m·K); the optical device structure layer formed based on the top silicon layer in the SOI substrate sequentially from bottom to top includes: a protection layer located above the heat isolation substrate and fixedly connected with the heat isolation substrate; and a first optical device layer located on the protection layer and including at least one first optical device; where a light beam emitted through the optical device structure layer is emitted upwards to a detection space.

As a solution, a thickness of the heat isolation substrate is greater than 50 μm.

As a solution, when the heat isolation substrate is in the laminated structure, a thickness of the material layer formed of the material with a thermal conductivity less than 100 W/(m·K) is greater than or equal to 10 μm.

As a solution, a material of the heat isolation substrate includes one or more of silicon dioxide, quartz, glass and plastic.

As a solution, the first optical device layer is formed of a silicon material; and the optical device structure layer further includes: a second optical device layer located between the first optical device layer and the protection layer, formed of a silicon nitride material and including at least one second optical device; and a first spacer layer located between the first optical device layer and the second optical device layer for spacing the first optical device layer and the second optical device layer.

As a solution, first optical devices in the first optical device layer include a first coupler, a first beam splitter, a first phase shifter and a first optical antenna; second optical devices in the second optical device layer includes a second coupler, a second beam splitter, a second phase shifter and a second optical antenna; where when the first optical devices in the first optical device layer are combined with the second optical devices in the second optical device layer, at least part of a third coupler, a third beam splitter, a third phase shifter and a third optical antenna are formed by coupling.

As a solution, the optical device structure layer further includes: a reflection layer located between the second optical device layer and the protection layer and including a reflection structure, where the reflection structure is configured to upwardly reflect light beams emitted from at least some optical antennas of the first optical antenna, the second optical antenna and the third optical antenna; a second spacer layer located between the reflection layer and the second optical device layer for spacing the reflection layer and the second optical device structure.

As a solution, a projection of the reflection layer in a vertical direction partially or completely overlaps with a projection of any one or more optical antennas of the first optical antenna, the second optical antenna and the third optical antenna in the vertical direction.

As a solution, the optical device structure layer further includes: an optical correction structure located between the reflection layer and the protection layer, for heating the first optical antenna to change part or whole refractive index of any one or more optical antennas of the first optical antenna, the second optical antenna and the third optical antenna.

As a solution, the optical correction structure includes a plurality of groups of heating structures, and different groups of heating structures in the plurality of groups of heating structures are configured to heat different parts of any one or more optical antennas of the first optical antenna, the second optical antenna and the third optical antenna.

According to another aspect of the embodiments of the present application, a preparation method for an optical chip is provided, including: providing an SOI substrate; forming an optical device structure layer on a top silicon layer of the SOI substrate, including: forming a first optical device layer in the top silicon layer of the SOI substrate, where the first optical device layer includes at least one first optical device; and depositing a silicon dioxide material on the SOI substrate, where the first optical device layer is formed, to form a protection layer; providing a heat isolation substrate and fixing the heat isolation substrate on the protection layer, and then removing all or part of a substrate silicon layer in the SOI substrate; where the heat isolation substrate is in a single-layer material structure or a laminated structure including a plurality of material layers, and the heat isolation substrate includes at least one material layer formed of a material with a thermal conductivity less than 100 W/(m·K); and a light beam emitted through the optical device structure is emitted upwards to a detection space.

As a solution, a thickness of the heat isolation substrate is greater than 100 μm; and when the heat isolation substrate is in the laminated structure, a thickness of the material layer formed of the material with a thermal conductivity less than 100 W/(m·K) is greater than or equal to 10 μm.

As a solution, the heat isolation substrate is formed of one or more materials of silicon dioxide, quartz, glass and plastic.

As a solution, the forming the optical device structure layer on the top silicon layer of the SOI substrate further includes: before forming the protection layer, depositing a silicon dioxide material on the SOI substrate, where the first optical device layer is formed, to form a first spacer layer; and forming a silicon nitride material layer on the first spacer layer, and forming a second optical device layer in the silicon nitride material layer, wherein the second optical device layer includes at least one second optical device; where first optical devices in the first optical device layer include a first coupler, a first beam splitter, a first phase shifter and a first optical antenna, and second optical devices in the second optical device layer include a second coupler, a second beam splitter, a second phase shifter and a second optical antenna; and when the first optical devices in the first optical device layer are combined with the second optical devices in the second optical device layer, at least part of a third coupler, a third beam splitter, a third phase shifter and a third optical antenna are formed by coupling.

As a solution, the forming the optical device structure layer on the top silicon layer of the SOI substrate further includes: before forming the protection layer, depositing a silicon dioxide material on the SOI substrate where the second optical device layer is formed to form a second spacer layer; and forming a reflection layer on the second spacer layer, wherein the reflection layer includes a reflection structure, and the reflection structure is configured to reflect light beams emitted from at least some optical antennas of the first optical antenna, the second optical antenna and the third optical antenna, so that the light beams penetrate the SOI substrate and are emitted into a detection space.

As a solution, the forming the optical device structure layer on the top silicon layer of the SOI substrate further includes: before forming the protection layer, depositing a silicon dioxide material on the SOI substrate, where the reflection layer is formed, to form a third spacer layer; forming a metal material layer on the third spacer layer, and forming an optical correction structure through a patterning process, wherein the optical correction structure is configured to change part or whole refractive index of any one or more of the first optical antenna, the second optical antenna and the third optical antenna.

In the embodiments of the present application, an optical chip includes a heat isolation substrate and an optical device structure layer located above the heat isolation substrate, where the heat isolation substrate is in a single-layer material structure or a laminated structure including a plurality of material layers, and the heat isolation substrate includes at least one material layer formed of a material with a thermal conductivity of less than 100 W/(m·K), while the optical device structure layer is formed based on a top silicon layer in an SOI substrate, the substrate silicon layer of the SOI will be partially or completely removed, so that heat transmitted from the substrate to the whole optical chip can be reduced without introducing additional electrical power consumption, thereby effectively solving the problem of thermal crosstalk. In addition, a light beam emitted by the optical device structure layer in the optical chip is emitted upwards to a detection space without passing through the heat isolation substrate, which avoids the influence of the heat isolation substrate on the emission quality of the light beam. In addition, the optical chip from bottom to top sequentially includes the heat isolation substrate and the optical device structure layer, the overall process is simple, optical devices are highly integrated, and the structure is compact, this is beneficial to mass production and may greatly reduce the product cost.

### BRIEF DESCRIPTION OF DRAWINGS

The drawings described herein are provided to provide a further understanding of the present application and constitute a part of the present application, the exemplary embodiments of the present application and illustration thereof are used to explain the present application and do not constitute undue limitations on the present application. In the drawings:

FIG. 1 is a schematic diagram of an optical chip of an embodiment of the present application;

FIG. 2 is a schematic diagram of light emitted from an optical chip of an embodiment of the present application;

FIG. 3 is a schematic diagram of another optical chip of an embodiment of the present application;

FIG. 4 is a schematic diagram of an optical device layer of an embodiment of the present application;

FIG. 5 is a schematic diagram of another optical device layer of an embodiment of the present application;

FIG. 6 is a schematic diagram of yet another optical chip of an embodiment of the present application;

FIG. 7 is a schematic diagram of yet another optical chip of an embodiment of the present application;

FIG. 8 is a schematic diagram of yet another optical chip of an embodiment of the present application;

FIG. 9 is a schematic diagram of yet another optical chip of an embodiment of the present application;

FIG. 10 is a schematic diagram of yet another optical chip of an embodiment of the present application;

FIG. 11 is a flow diagram of a preparation method for an optical chip of an embodiment of the present application;

FIG. 12 is a schematic diagram of a preparation method for an optical chip of an embodiment of the present application;

FIG. 13 is a schematic diagram of another preparation method for an optical chip of an embodiment of the present application;

FIG. 14 is a schematic diagram of yet another preparation method for an optical chip of an embodiment of the present application;

FIG. 15 is a schematic diagram of yet another preparation method for an optical chip of an embodiment of the present application;

FIG. 16 is a schematic diagram of yet another preparation method for an optical chip of an embodiment of the present application; and

FIG. 17A, FIG. 17B, FIG. 17C are schematic diagrams of yet another preparation method for an optical chip of an embodiment of the present application.

### DETAILED DESCRIPTION

Embodiments of the present application are described in detail below, examples of the embodiments are shown in the drawings, in which identical or similar reference numerals throughout represent identical or similar elements or elements with identical or similar functions. The embodiments described below with reference to the drawings are exemplary and intended to explain the present application, but cannot be understood as a limitation of the present application.

In the description of the present application, it should be understood that orientations or position relationships indicated by terms “length”, “width”, “up”, “down”, “front”, “back”, “left”, “right”, “vertical”, “horizontal”, “top”, “bottom”, “inside”, “outside”, etc. are orientations or position relationships based on those shown in the drawings, which is only for the convenience of describing the present application and simplifying the description, and does not indicate or imply that an apparatus or an element referred to must have a specific orientation or be constructed and operated in a specific orientation, and therefore, cannot be understood as a limitation of the present application.

In addition, terms “first” and “second” are only for the purpose of description and cannot be understood as indicating or implying relative importance or implicitly indicating the quantity of technical features. Therefore, features defined with “first” and “second” can explicitly or implicitly include one or more of this feature. In the description of the present application, “a plurality of” means two or more than two, unless otherwise defined clearly.

In the present application, unless otherwise specified and defined, terms “installation”, “link”, “connection”, “fixation” should be broadly understood, for example, they may be a fixed connection, a detachable connection, or an integrated connection; they may be a mechanical connection or an electrical connection; they can be directly connection or indirectly connection through an intermediate medium, they can be an internal communication of two components or an interaction relationship between two components. For those of ordinary skill in the art, specific meanings of the terms described above in the present application may be understood based on specific circumstances.

In order to make the purposes, technical solutions, and advantages of the present application clearer and more understandable, the present application will be further explained in detail in conjunction with the drawings and embodiments below.

According to one aspect of the embodiments of the present application, an optical chip is provided. The optical chip is an integrated circuit that uses optical technology to process and transmit information. It uses photons to transmit data, which may realize high-speed, high-bandwidth and low-energy data transmission and processing. As a kind of optical chip, a silicon optical chip is an optical chip made of a silicon material, which may be used in fields of optical communication, optical sensing, laser radar and so on. The silicon optical chip may convert an optical signal into an electrical signal or convert an electrical signal into an optical signal, and have excellent photoelectric performance.

The silicon optical chip includes a substrate and functional layers, where the substrate is the basic part of the silicon optical chip, usually made of a silicon material, and plays the role of support and carrier in the manufacturing process of the silicon optical chip; the functional layers of the silicon optical chip are patterns and structures formed based on a silicon-based material layer and CMOS technology. These patterns and structures include optical devices such as a coupler, a beam splitter, a phase shifter, an optical antenna and electrodes connected with the optical devices and so on, which form the functional parts of the chip.

At present, SOI is usually used as a substrate for silicon optical chips, integrated optical devices are processed and fabricated on the top silicon, and after fabrication, a silicon dioxide layer is grown on the top to protect optical devices. However, the substrate silicon in the SOI substrate is usually about 700 μm in thickness, and even though the thickness may be thinned to about 400 μm by a grinding and polishing process, it is still 2 to 3 orders of magnitude different from the thickness of 220 nm of the top silicon and the thickness of 2 μm or 3 μm of the silicon dioxide layer in the SOI substrate. Silicon has a thermal conductivity of about 150 W/(m·K), and is a material with good thermal conductivity. If there are optical devices that generate heat in parts of the optical chip, heat may be quickly transmitted to the whole optical chip through the thick substrate silicon, resulting in serious thermal crosstalk.

In the related art, TEC may be added to a bottom of an optical chip as a heat dissipation device, so as to quickly dissipate heat generated in the optical chip and reduce the internal heat accumulation. However, although the above solution can partially solve the problem of thermal crosstalk, the electrical power consumption of the TEC needs to be increased to a Watt level if a better result is to be obtained, which may generate more heat, and is also unacceptable for optical chips.

In order to at least partially solve the above technical problems, in an embodiment, for an optical chip, a substrate silicon layer is removed and a material with a low thermal conductivity is adopted for the substrate, which may reduce heat transmitted from the substrate to the whole optical chip without introducing additional electrical power consumption, thereby effectively solving the problem of thermal crosstalk. Besides, it also enables the optical devices that need to be heated up to increase the temperature more effectively at low power consumption input. For example, when the phase shifter is heated through a TEC, due to the heat isolation substrate has a low thermal conductivity, heat energy cannot be transmitted from the substrate, so the temperature may be increased effectively.

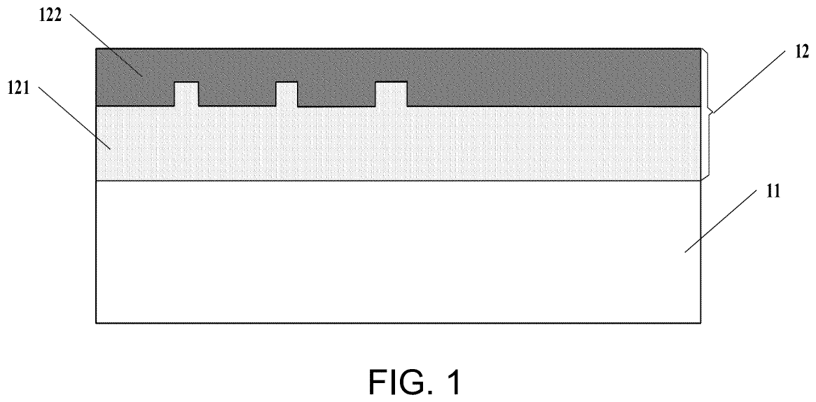

As an implementation, FIG. 1 is a schematic diagram of an optical chip of an embodiment of the present application. As shown in FIG. 1, an optical chip may include a heat isolation substrate 11 and an optical device structure layer 12.

The heat isolation substrate 11 may be in a single-layer material structure or a laminated structure including a plurality of material layers, and at least one material layer formed of a material with a thermal conductivity of less than 100 W/(m·K) (for example, quartz, glass, etc., but not limited thereto) is included in the heat isolation substrate, the material layer has a better thermal isolation effect compared to silicon with the thermal conductivity of about 150 W/(m·K), which can effectively reduce heat conducted to the entire optical chip through the substrate, and can effectively prevent thermal crosstalk, and improve local heating efficiency.

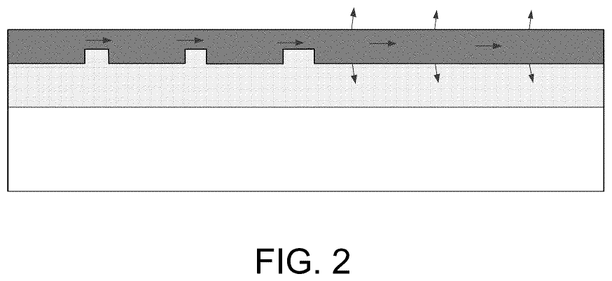

The optical device structure layer 12 may be located above the heat isolation substrate and formed based on a top silicon layer in the SOI substrate, and a light beam emitted by the optical device structure layer 12 may be emitted upwards to a detection space, as shown in FIG. 2 (the upward arrow in FIG. 2 is used to indicate a direction of the emitted light). It may be understood that the upward emitted of the light beam means that the light beam is emitted in a direction from the heat isolation substrate to the optical device structure layer. In the optical chip shown in FIG. 2, the heat isolation substrate is at the bottom and the optical device structure layer is at the top. Therefore, the upward emitted the light beam means that the light beam is emitted in a direction from the heat isolation substrate to the optical device structure layer.

Forming the optical device structure layer 12 based on the top silicon layer in the SOI substrate may be obtained by the following method: during the preparation of the optical chip, forming the optical device structure layer 12 on the top silicon layer in the SOI substrate first, and then removing all or part of the substrate silicon layer in the SOI substrate, or it may be obtained by other methods, as long as the optical device structure layer formed based on the top silicon layer in the SOI substrate can be obtained.

The optical device structure layer 12 sequentially from bottom to top (from a direction close to the substrate to a direction far away from the substrate) includes: a protection layer 121 and a first optical device layer 122, here, the protection layer 121 is located above the heat isolation substrate 11 and fixedly connected with the heat isolation substrate 11, so as to play the role of fixing and protecting and improve the structural stability of the optical chip, and its material may be silicon dioxide (SiO₂). The first optical device layer 122 is located on the protection layer 121 and may include at least one first optical device, for example, all or part of a light source (a laser light source), a coupler, a beam splitter, a phase shifter and an optical antenna. Here, through the design of the optical chip described above, the overall process of the optical chip is simple, optical devices are highly integrated, and the structure is compact. This is beneficial to mass production and may greatly reduce the product cost.

It is to be noted that a protection layer (for example, made of silicon dioxide) is usually covered above optical devices, so as to prevent the optical device layer from being directly exposed to the air. And after the optical devices are formed, the corresponding metal wiring is also carried out. By adding the protection layer after the metal wiring, metal wires may be prevented from being oxidized or damaged due to contact with air. A thickness of the protection layer is usually 1 μm to 2 μm, or 3 μm, as long as it may play a protective role. In a word, the protection layer may not only protect optical devices, but also protect metal devices, while providing electrical isolation, which may prevent devices from being directly exposed to the air, and may also play a role of preventing devices from being dirty and avoiding artificial damage. A light transmittance of the protection layer is a light transmittance that meets the requirements of the light beam transmission or high transmission (that is, the light transmittance of the protection layer meets light transmittance requirements of the emitted light beam).

According to an embodiment provided in the present application, an optical chip includes a heat isolation substrate and an optical device structure layer located above the heat isolation substrate and formed based on a top silicon layer in an SOI substrate; where the heat isolation substrate is in a single-layer material structure or a laminated structure including a plurality of material layers, and at least one material layer formed of a material with a thermal conductivity less than 100 W/(m·K) is included in the heat isolation substrate; and an optical device structure layer formed based on the top silicon layer in the SOI substrate from bottom to top sequentially includes: a protection layer located above the heat isolation substrate and fixedly connected with the heat isolation substrate; and a first optical device layer located on the protection layer and including at least one first optical device; where a light beam emitted by the optical device structure is emitted upwards to a detection space. This solves the problem of serious thermal crosstalk in optical chips, reduces the thermal crosstalk and improves the service life of optical chips.

As a solution, a thickness of the heat isolation substrate is not fixed based on different structures of the heat isolation substrate and different materials used in the material layer. Although the heat isolation substrate is made of a material with a low thermal conductivity, its thermal isolation ability is not only related to the thermal conductivity of the material, but also related to the thickness of the heat isolation substrate. In order to improve the thermal resistance capacity of the heat isolation substrate, the thickness of the heat isolation substrate may be greater than 100 μm. At the same time, setting the thickness of the heat isolation substrate to be greater than 100 μm may also play a better supporting role.

Here, it is proved by simulation experiments that for a material with a low thermal conductivity (a small thermal conductivity coefficient), the greater the thickness, the worse the heat conduction effect (the higher the thermal resistance), and the smaller the thickness, the better the heat conduction effect (the lower the thermal resistance). Therefore, for the heat isolation substrate, in order to ensure its better thermal resistance ability, its thickness may be controlled above 100 μm, and mechanical stress requirements are taken into account, thereby improving the mechanical strength of the heat isolation substrate.

In an implementation, for the heat isolation substrate in a laminated structure, the thickness of the material layer made of a material with a thermal conductivity less than 100 W/(m·K) may be controlled to be greater than or equal to 10 μm to improve the thermal isolation effect of the heat isolation substrate, and when combined with the design that the thickness of the heat isolation substrate is greater than 100 μm, the supporting capacity and thermal resistance capacity of the heat isolation substrate may be ensured simultaneously.

Through the embodiment provided in the present application, the thickness of the heat isolation substrate is controlled to be greater than 100 μm, which may not only ensure the thermal resistance capacity of the heat isolation substrate, but also play a good supporting role; the thickness of the material layer formed of the material with a thermal conductivity less than 100 W/(m·K) is controlled to be greater than or equal to 10 μm, which may improve the thermal resistance capacity of the heat isolation substrate.

As a solution, the heat isolation substrate may be in a single-layer material structure or a laminated structure including a plurality of material layers, and the material forming each material layer in the single-layer material structure or the laminated structure may include one or more of silicon dioxide, quartz, glass, low-density silicon and plastic.

A thermal conductivity of silicon dioxide is about 1.4 W/(m·K), a thermal conductivity of quartz is about 7 W/(m·K), a thermal conductivity of low-density silicon may be controlled to be less than 100 W/(m·K), and a thermal conductivity of plastic is generally in a range of 0.1 W/(m·K) to 0.5 W/(m·K). The material used to the material layer formed of the material with a thermal conductivity less than 100 W/(m·K) may be one of silicon dioxide, quartz, glass, low-density silicon and plastic, but it is not limited thereto, and may also be other materials with a thermal conductivity less than 100 W/(m·K).

According to an embodiment provided in the present application, the heat isolation substrate adopts a glass substrate (which may be silicon dioxide glass or quartz glass), because the glass substrate not only has a low thermal conductivity, but also is easier to be obtained and lower in cost.

As a solution, the first optical device layer is formed of a silicon material. The SOI substrate is in a laminated structure including a substrate silicon, a buried oxide layer and a top silicon, and an optical device is usually formed in the top silicon. In the embodiment of the present application, the first optical device is formed in the top silicon. Although the silicon material has the advantages of common and low cost, the silicon material is a strongly nonlinear material, especially has strong two-photon absorption effect and free carrier absorption effect, and its low-order nonlinear coefficient is also very large, so it is not suitable for high-power light injection. In this regard, another optical device layer formed of another material may be used to adapt to high-power light injection.

In an implementation, a second optical device layer may be formed by using a material with a lower nonlinear coefficient than silicon (for example, a silicon nitride material). Light coupled to the optical chip is first split in the second optical device layer, and the optical power of each part of light after splitting is much lower than that of the light coupled to the chip. When light is split into enough parts, the optical power of each part of light is small enough so that each part of light may be transmitted normally in the optical device layer. Therefore, it may adapt to the light injection with higher power, that is, the optical power input into the chip may be greatly increased, thus greatly improving the detection performance of lidar, and reducing a lot of pressure on the signal detection part. For example, a second beam splitter is included in the second optical device layer, and an interlayer coupling structure (for example, a wedge coupler or a grating coupler) is disposed between the first beam splitter and the second beam splitter, and the first beam splitter and the second beam splitter are optically connected through this interlayer coupling structure, and the interlayer coupler may form a third coupler (which is an interlayer coupler). Therefore, after high-power light is coupled to the optical chip, the light beam is first split by the second beam splitter (for example, one is split into two, two is split into four, and four is split into eight, etc.), and after the splitting is completed, each split light beam can be ensured to be transmitted normally in the optical device layer; at this time, the split light beam is guided into a silicon material through the interlayer coupler (here, an optical waveguide optically connected with the coupler may be disposed behind the coupler, and the optical waveguide may be made of a silicon material) for propagation, so that two-photon absorption and the like may be avoided. By adopting the above method, the advantages of different materials may be combined to improve the reliability of light beam propagation. Of course, the first optical device layer and the second optical device layer may also be used independently, and not necessarily in combination.

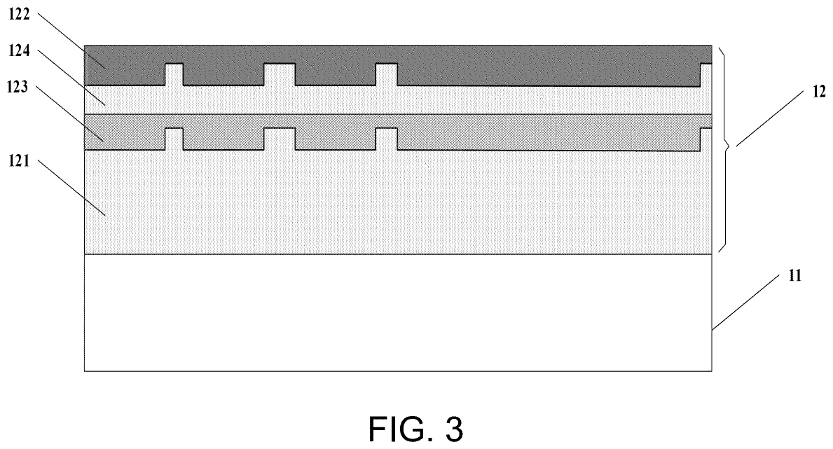

In this embodiment, the second optical device layer is located between the first optical device layer and the protection layer, and the two optical device layers may be adjacent structures, that is, the two optical device layers may be directly grown together. However, when the optical chip is prepared in this way, two optical device layers may influence each other, and the requirements for preparation accuracy are high. To solve the problem, in some other embodiments, a spacer layer (a buffer layer) may be added between the first optical device layer and the second optical device layer to physically isolate the adjacent optical device layers (to separate the adjacent optical device layers). As shown in FIG. 3, in addition to the first optical device layer 122, the optical device structure layer 12 may further include a second optical device layer 123 and a first spacer layer 124.

The second optical device layer 123 is located between the first optical device layer 122 and the protection layer 121, and may be made of a silicon nitride material and includes at least one second optical device. The type, number and position of the second optical device included in the second optical device layer 123 may be the same as or correspond to or at least partially different from the type, number and position of the first optical device included in the first optical device layer 122.

The first spacer layer 124 is located between the first optical device layer 122 and the second optical device layer 123 for spacing the first optical device layer 122 and the second optical device layer 123.

In an implementation, the first spacer layer 124 may be formed of a silicon dioxide material. In a scene where the same optical devices on two optical device layers need to be coupled, a thickness of the spacer layer (that is, all the isolation layers in the embodiment of the present application, the first spacer layer is included) may be from tens of nanometers (for example, 50 nm) to hundreds of nanometers (for example, 100 nm), etc. to meet the coupling requirements of the optical devices. The light transmittance of the first spacer layer 124 is a light transmittance that meets the requirements of transmission of light beams therethrough or high transmission (that is, the light transmittance of the first spacer layer 124 meets the requirements of the light transmittance of emitted light beams).

According to an embodiment provided in the present application, the optical device structure layer includes a plurality of optical device layers made of different materials, so that the advantages of different materials may be combined to improve the reliability of light beam propagation; and a spacer layer is disposed between adjacent optical device layers to space the adjacent optical device layers, which may reduce the difficulty of preparing the optical device layers.

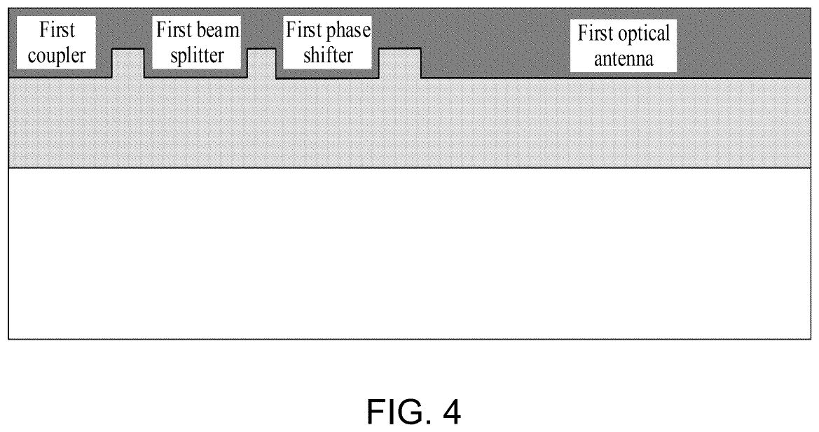

As a solution, optical devices included in the first optical device layer 122 may be a first coupler, a first beam splitter, a first phase shifter and a first optical antenna, and the relationship of positions of the optical devices may be as shown in FIG. 4.

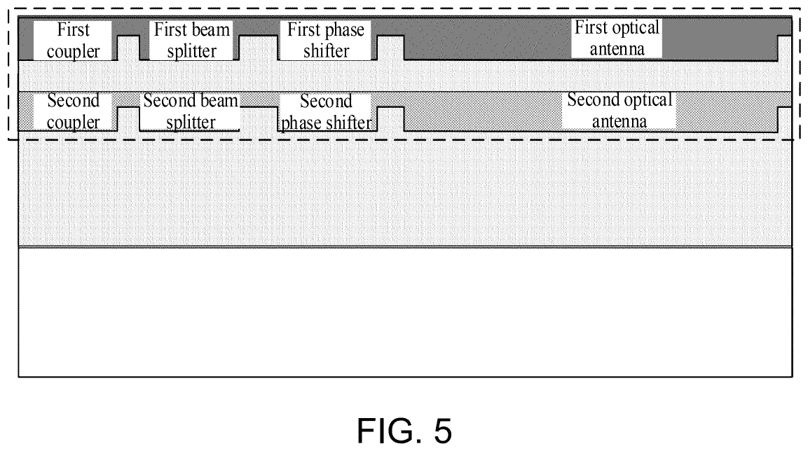

In an implementation, optical devices included in the second optical device layer 123 may be a second coupler, a second beam splitter, a second phase shifter and a second optical antenna, and the relationship of positions of the optical devices in the second optical device layer may be as shown in FIG. 5. It is to be particularly pointed out that the structure shown in FIG. 5 is only an example, and projections of the same optical devices in the vertical direction may partially overlap or completely not overlap; for example, the projections of the first optical antenna and the second optical antenna in the vertical direction may completely overlap, partially overlap or completely not overlap.

Here, in the first optical device layer 122 and the second optical device layer 123, some of the identical optical devices may be coupled. For example, when optical devices in the first optical device layer are combined with optical devices in the second optical device layer, interlayer optical devices may be formed, which may include all or some of a third coupler, a third beam splitter, a third phase shifter and a third optical antenna. That is, the first coupler and the second coupler may form the interlayer third coupler, and light may be coupled to the optical chip through the third coupler, which may improve the optical coupling efficiency, and at the same time, reduce the volume of the coupling device. The first beam splitter and the second beam splitter may be combined to form the third beam splitter, and through the coupling of the beam splitters, the cascading of the SiN beam splitter and the Si beam splitter may be achieved, allowing a light beam to be split through the SiN beam splitter first to reduce the optical power, ensuring that each part of light beam may be transmitted normally in the optical device layer, thereby greatly improving the optical power input into the optical chip. The first phase shifter and the second phase shifter may be combined to form the third phase shifter, and through the coupling of the phase shifters, the phase of the light beam may be changed by using the electro-optical/thermo-optical effect under the condition that the functions of the phase shifters remain unchanged. The first optical antenna and the second optical antenna may be combined to form the third optical antenna, and through the coupling of the optical antennas, the emission power may be improved. Here, the third coupler, the third beam splitter, the third phase shifter and the third optical antenna formed by coupling may be used as the third optical device layer, that is, the structure shown in the dashed box in FIG. 5.

According to an embodiment provided in the present application, different light beam transmission requirements may be met through interlayer coupling of identical optical devices in different optical device layers.

It should be noted that the first optical antenna and the second optical antenna may be partially coupled, a part of the first optical antenna that is not coupled with the second optical antenna is still the first optical antenna, a part of the first optical antenna that is coupled with the second optical antenna is coupled as the third optical antenna, a part of the second optical antenna that is not coupled with the first optical antenna is still the second optical antenna, and a part of the second optical antenna that is coupled with the first optical antenna is coupled as the third optical antenna. That is, the part of the first optical antenna that is not coupled with the second optical antenna is still the first optical antenna, the part of the second optical antenna that is not coupled with the first optical antenna is still the second optical antenna, and the part of the first optical antenna and the part of the second optical antenna that are coupled are the third optical antenna.

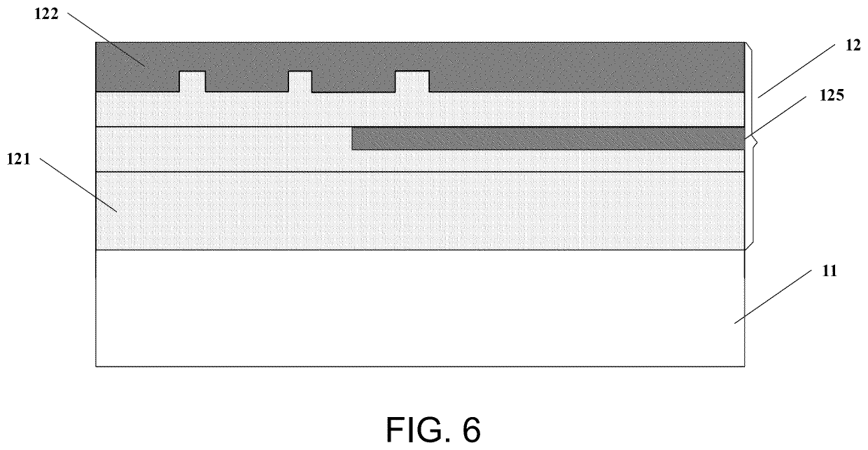

As a solution, it may be understood that light beams may be emitted upwards and downwards from the optical antenna, and only the upward light beam may be used to detect targets, and light beams in other directions may be wasted and even become noise, which may affect the detection accuracy. In this regard, in this embodiment, a reflection layer may be added to the optical device structure layer, the reflection layer may be located between the first optical device layer and the protection layer, and may include a reflection structure which is used to reflect the light beam emitted from the optical antenna (for example, the first optical antenna) upwards. As shown in FIG. 6, a reflection layer 125 is added between the first optical device layer 122 and the protection layer 121, and may be used to reflect the light beam emitted by the first optical antenna upwards. Light beam emitted by the optical antenna and reflected by the reflection structure results in that the reflected light emits upwards to the detection space, which may improve the emission efficiency of the optical antenna, reduce the light loss and improve the utilization efficiency of the input light.

It should be noted that the reflection layer may be a laminated structure, one of which is a reflection structure, and the other structures may be structures with other functions, that is, there are at least some structures in the reflection layer but not necessarily the whole reflection layer that can reflect light.

In the case that the optical device structure layer includes the second optical device layer, the reflection layer may be located between the second optical device layer and the protection layer, and the reflection structure of the reflection layer is used to reflect the light beams emitted from at least some optical antennas of the first optical antenna, the second optical antenna and third optical antenna upward. Here, light emitted by optical antennas is reflected by the reflecting structure, so that the reflected light emitted upwards to the detection space, thereby improving the emission efficiency of the optical antennas, reducing the light loss and improving the utilization efficiency of the input light.

In an implementation, a second spacer layer may be disposed between the reflection layer and the second optical device layer for spacing the reflection layer and the second optical device layer. A material and thickness used to the second spacer layer may be the same as or similar to the material and thickness used to the first spacer layer, and will not be described in detail here. Usually, a silicon dioxide material is used to prepare the spacer layer and the protection layer.

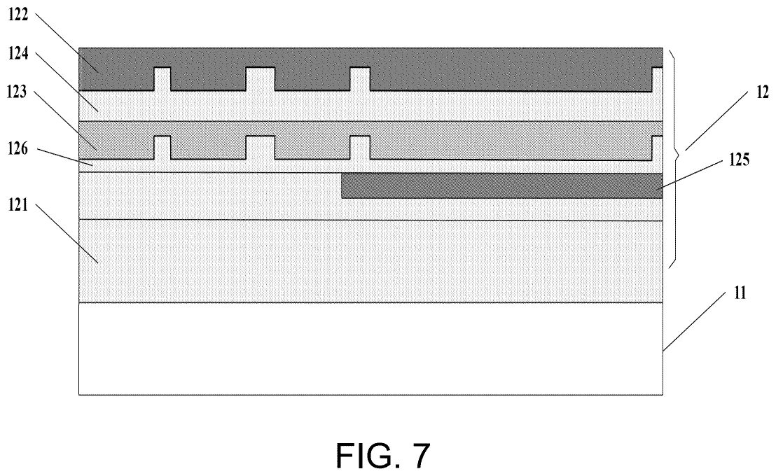

Exemplarily, as shown in FIG. 7, the reflection layer 125 is located between the second optical device layer 123 and the protection layer 121, and may be used to reflect the light beams emitted by at least some optical antennas of the first optical antenna, the second optical antenna and the third optical antenna upward. While the second spacer layer 126 is disposed between the reflection layer 125 and the second optical device layer 123, and the reflection layer 125 and the second optical device layer 123 may be spaced by the second spacer layer 126, so that this may prevent the optical devices in the second optical device layer from being damaged in the process of forming the reflection layer, and reduce the difficulty of preparing the optical chip.

As a solution, the position of the reflection layer may be set based on the positions of the first optical antenna, the second optical antenna and the third optical antenna, and a projection of the reflection layer in the vertical direction partially or completely overlaps with the projection of any one or more of the first optical antenna, the second optical antenna and the third optical antenna in the vertical direction. In order to ensure that the reflection layer may adapt to the first optical antenna, the second optical antenna and the third optical antenna, the projection of the reflection layer in the vertical direction partially overlaps with the projection of any one of the first optical antenna, the second optical antenna and the third optical antenna in the vertical direction, for example, the projection of the reflection layer in the vertical direction completely covers the projections of the first optical antenna, the second optical antenna and the third optical antenna in the vertical direction.

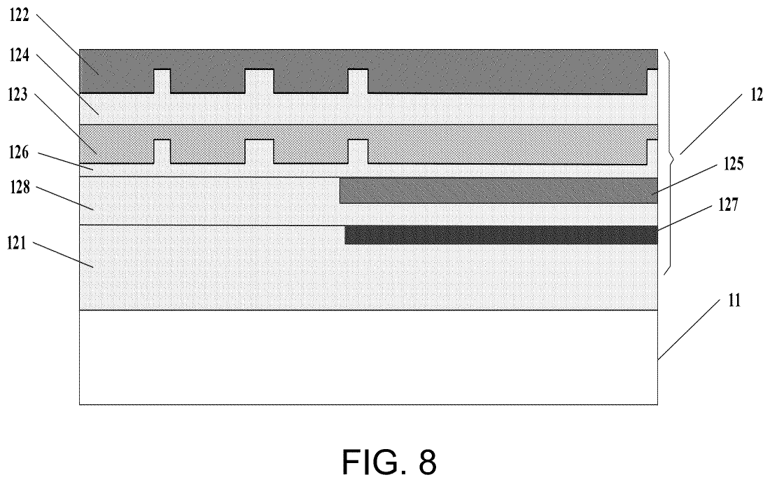

As a solution, in order to improve the detection capability of the optical antennas, an optical correction structure may be disposed in the optical device structure layer. As shown in FIG. 8, the optical device structure layer 12 further includes an optical correction structure 127, which may be located between the reflection layer 125 and the protection layer 121 and may be used to change part or whole refractive index of at least some optical antennas of the first optical antenna, the second optical antenna and the third optical antenna. In order to protect the reflection layer 125, one spacer layer (i.e., a third spacer layer 128) may be disposed between the reflection layer 125 and the optical correction structure 127, and the third spacer layer 128 is used to space the reflection layer 125 and the optical correction structure 127.

The method of changing the refractive index of the antennas by the optical correction structure 127 may be heating any one or more of the first optical antenna, the second optical antenna and the third optical antenna, and the method of heating the optical antenna may be flexibly configured as required, so as to adjust the refractive index of the optical antenna according to different requirements, realize spot alignment, thereby improving the detection accuracy.

In an implementation, the optical correction structure 127 may include a heating electrode and a heating structure (for example, a heating resistor). By applying a bias voltage to the heating electrode, the heating structure generates heat and conducts it to the optical antenna, so as to heat the optical antenna, change the refractive index of the antenna, and thus change the direction of the emitted light beam corresponding to the antenna, thereby achieving spot alignment. The optical correction structure 127 may include a plurality of groups of heating structures, and each heating structure may be independently controlled for heating, so as to achieve accurate control of the optical antenna to be heated, compensate the inconsistency in the aperture of the optical antenna caused by the process, thereby improving the spot quality of the emitted light beam. The heating structures may be uniformly distributed above the corresponding optical antennas, the specific number may be set as required, and it is not limited in this embodiment.

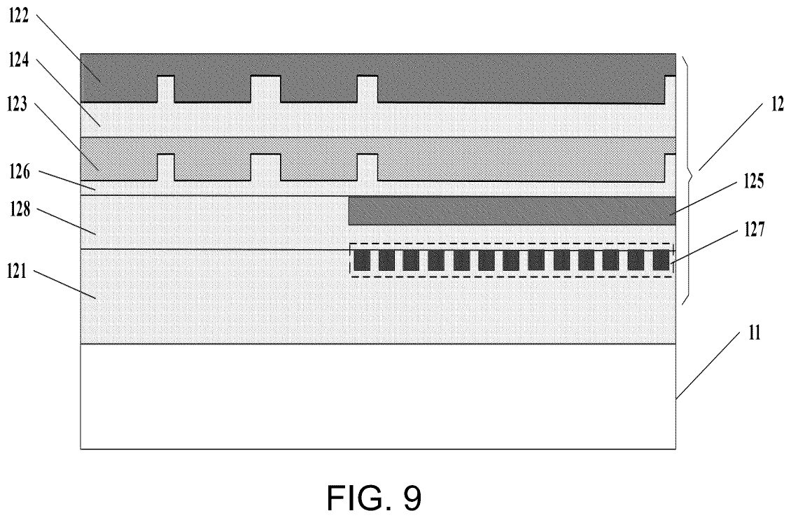

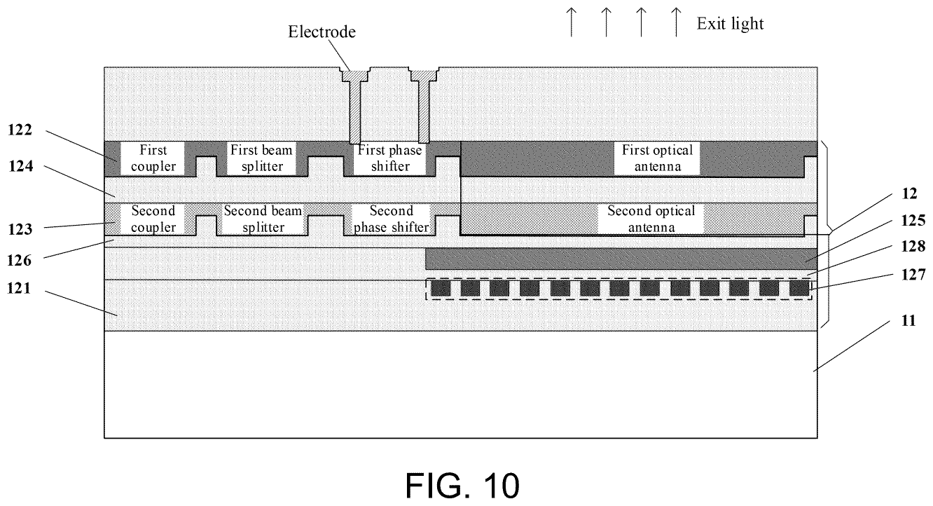

For example, as shown in FIG. 9 and FIG. 10, the optical correction structure 127 may include a plurality of groups of heating structures to heat optical antennas as needed.

According to an embodiment provided in the present application, the refractive index of the optical antenna is changed by heating the optical antenna through the optical correction structure, so that the direction of the emitted light corresponding to the antenna is changed, the spot alignment is achieved, and the detection capability of the optical chip is improved.

As a solution, when the optical correction structure includes a plurality of groups of heating structures (i.e., the plurality of groups of local heating structures mentioned above), the heating parameters (e.g., the applied bias voltage) of different groups of heating structures among the plurality of groups of heating structures may be the same, and may also be different. For each group of heating structures, they may be used to locally heat the first optical antenna. The optical antenna may be divided into an antenna matrix (each antenna matrix includes a group of local antennas), and a group of local antennas divided from the optical antenna may be heated by a group of heating structures, or it may not have a corresponding heating structure. The heating parameters of the heating structures corresponding to different groups of local antennas of the optical antenna may be the same, and may also be different. In addition, the dimensions of the heating structures in a group of heating structures may be the same, and may also be different.

An optical chip in an embodiment of the present application is explained in combination with examples. As shown in FIG. 10, an optical chip includes an optical device structure layer 12 and a heat isolation substrate 11; the optical device structure layer 12 sequentially from top to bottom includes a first optical device layer 122, a first spacer layer 124, a second optical device layer 123, a second spacer layer 126, a reflection layer 125, a third spacer layer 128, an optical correction structure 127, and a protection layer 121. Where a material of the heat isolation substrate 11 may be glass, and a material of the protection layer 121 may be silicon dioxide. Here, the heat isolation substrate includes at least one material layer made of a material with a thermal conductivity less than 100 W/(m·K). Through the above structure, not only a better thermal isolation effect may be achieved, but also the emission efficiency of optical antennas may be improved and the light loss may be reduced.

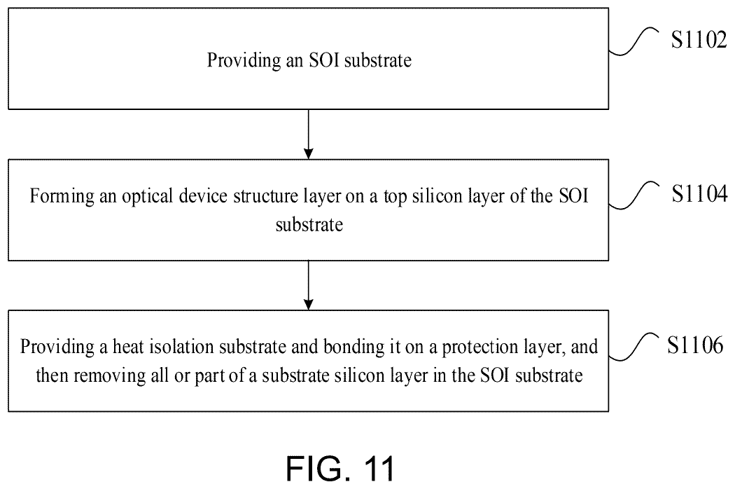

According to another aspect of the embodiments of the present application, a preparation method for an optical chip is also provided, which may be used to prepare the optical chip in any of the above embodiments, and what has already been described is not repeated here. FIG. 11 is a schematic flow diagram of a preparation method for an optical chip according to an embodiment of the present application. As shown in FIG. 11, the flow of the above method may include the following steps:

Step S1102, providing an SOI substrate.

In this embodiment, after a process (an optical device structure) is completed on the front of a SOI substrate, the device may be bonded to another carrier substrate (a heat isolation substrate) from the front thereof, and then all or part of SOI substrate silicon is removed to complete the preparation of the optical chip. That is, an optical device structure layer is first formed based on a top silicon layer in the SOI substrate, then a heat isolation substrate is bonded on the formed optical device structure layer, and finally all or part of SOI substrate silicon is removed. Through the preparation setting of the optical chip described above, the supporting capacity of the SOI substrate is utilized, and the efficiency and convenience of the preparation of the optical chip are improved.

It should be noted that the term “substrate” may refer to a substrate of a cut wafer, or may refer to a substrate of an uncut wafer. The term “layer” includes a thin film and should not be interpreted to indicate vertical or horizontal thickness unless otherwise specified. The SOI substrate is easy to obtain and has good characteristics for integrated photonic device.

Based on the preparation solution of the optical chip described above, an SOI substrate may be provided first, the SOI substrate may be provided by a mechanical arm or other control parts, and the SOI substrate is placed on an insulator placed on an operating table. The SOI substrate may be pre-produced and placed in a designated position, or other providing methods for the SOI substrate may be adopted.

Step S1104, forming an optical device structure layer on a top silicon layer of the SOI substrate.

The SOI substrate may include a top silicon layer, a buried oxygen layer (i.e., a buried silicon dioxide layer) and a substrate silicon layer. An optical device structure layer (for example, the aforementioned optical device structure layer) may be formed on the top silicon layer of the provided SOI substrate, and a light beam emitted through the optical device structure layer is emitted upwards to a detection space. The optical device structure layer may include a first optical device layer including at least one first optical device, for example, a first coupler, a first optical waveguide, a first beam splitter, a first phase shifter, a first optical antenna, etc. Correspondingly, the forming the optical device structure layer on the top silicon layer of the SOI substrate may include forming a first optical device layer in the top silicon layer of the SOI substrate.

There may be one or more methods to form the first optical device layer on the top silicon layer, and for different first optical devices, the forming methods may be the same, and may also be different. The forming method of the optical device may include but is not limited to at least one of the following: a micromachining process (for example, a bulk silicon processing process), a patterning process, and other processing processes, and it is not limited in this embodiment.

In an implementation, the at least one first optical device may include a coupler, which may be fabricated by any suitable micromachining process. Taking the bulk silicon processing process as an example, part of the silicon material is selectively removed in the top silicon layer according to a design pattern to form a designed micro three-dimensional structure. The patterning process of the coupler may include etching, such as wet etching and dry etching. Depending on the etching rate in different crystal directions in an etching solution, the wet etching may be divided into an isotropic etching and an anisotropic etching. The dry etching adopts a physical method (e.g., sputtering and ion etching) or a chemical method (e.g., reactive ion etching). The at least one first optical device may also be an optical waveguide (which may be optically coupled with a coupler, for example, a strip optical waveguide) and other optical devices, for example, an edge coupler, a waveguide crossover, a beam splitter and an optical antenna, and may further include an active device based on the optical waveguide (for example, a phase shifter), and it is not limited in this embodiment.

After the first optical device layer is formed, the removed portion on the top silicon layer may be filled with an appropriate dielectric material (e.g., silicon dioxide) to prevent voids from appearing in the top silicon layer. Exemplarily, silicon dioxide may be deposited in the patterned top silicon layer through CVD (Chemical Vapor Deposition) process, or PVD (Physical Vapor Deposition) process, or PECVD (Plasma Enhanced Chemical Vapor Deposition) process, or HDP (High Density Plasma) deposition process.

A protection layer may be formed on the SOI substrate on which the first optical device layer is formed, and the material, thickness, light transmittance and the like of the protection layer are similar to those of the aforementioned embodiments, and it is not repeated here. The protection layer may be formed by depositing a silicon dioxide material, for example, the protection layer is formed by depositing the silicon dioxide material through CVD process, PCD process, or PECVD process.

In an implementation, in addition to the first optical device layer, other device layers for example, at least one of a second optical device layer, a reflection layer and a optical correction structure may be formed before the protection layer is formed, and different device layers may be spaced by a spacer layer. A forming method of the spacer layer may be the same with or similar to the forming method of the protection layer.

Step S1106: providing a heat isolation substrate and fixing the heat isolation substrate on the protection layer, and then removing all or part of the substrate silicon layer in the SOI substrate.

After the protection layer is formed, a heat isolation substrate may be provided, and the provided heat isolation substrate is fixed on the protection layer. There are many methods to fix the heat isolation substrate on the protection layer, for example, the heat isolation substrate may be fixed on the protection layer by bonding, or the heat isolation substrate may be fixed on the protection layer by gluing (for example, the heat isolation substrate may be glued on the protection layer by glue), and the heat isolation substrate may also be fixed on the protection layer by other methods, and it is not limited in this embodiment. Here, the bonding process used for bonding may be a low-temperature bonding process, and may also be other bonding processes, as long as the heat isolation substrate and the protection layer may be closely connected together.

After the heat isolation substrate is fixed on the protection layer, the device (a semi-finished product, at this time, the optical chip is not finished) may be inverted (i.e., turned over) to expose the substrate silicon layer in the SOI substrate in the lowest layer, and all or part of the substrate silicon layer in the SOI substrate may be removed to obtain the optical chip structure in the above embodiment. The process of removing at least part of the substrate silicon layer may be achieved by etching, specifically a TMAH (Tetramethylammonium Hydroxide) solution may be used for etching; or the substrate silicon layer may first be thinned by wet etching, and then part of the substrate silicon layer is removed by dry etching. If part of the silicon layer in SOI substrate is removed, a thickness of the remaining substrate silicon layer is less than 100 μm.

Similar to the aforementioned embodiments, the heat isolation substrate is a single-layer material structure or a laminated structure including a plurality of material layers, and includes at least one material layer made of a material with a thermal conductivity less than 100 W/(m·K). For example, the heat isolation substrate may be a material with a thermal conductivity less than 100 W/(m·K), for example, quartz glass. For another example, the heat isolation substrate may be in a laminated structure of quartz glass layer and a silicon dioxide material layer. It is to be noted that when the heat isolation substrate is in a laminated structure, a thickness of the material layer formed of the material with a thermal conductivity less than 100 W/(m·K) is greater than or equal to 10 μm.

For the optical chip formed by the method provided in this embodiment, since the heat isolation substrate with a low thermal conductivity is adopted, the heat transmitted from the substrate to the whole optical chip may be reduced without introducing additional electrical power consumption, so that the problem of thermal crosstalk may be effectively solved. In addition, the light beam emitted through the optical device structure layer in the optical chip is emitted upwards to the detection space without passing through the heat isolation substrate, which avoids the influence of the heat isolation substrate on the emission quality of the light beam. In addition, the optical chip from bottom to top sequentially includes: the heat isolation substrate, the protection layer and the optical device structure layer, the overall process is simple, the optical devices are highly integrated and the structure is compact. This is beneficial to mass production and may greatly reduce the product cost.

As a solution, similar to that in the aforementioned embodiments, the thickness of the heat isolation substrate is greater than 100 μm; when the heat isolation substrate is a laminated structure, the thickness of the material layer formed of the material with a thermal conductivity less than 100 W/(m·K) is greater than or equal to 10 μm.

As a solution, similar to the aforementioned embodiments, one or more materials of silicon dioxide, quartz, glass and plastic are used to form the heat isolation substrate.

As a solution, the forming the optical device structure layer on the top silicon layer of an SOI substrate further includes: before forming a protection layer, depositing a silicon dioxide material on the SOI substrate, on which the first optical device layer is formed, to form a first spacer layer; forming a silicon nitride material layer on the first spacer layer, and forming a second optical device layer in the silicon nitride material layer, where the second optical device layer includes at least one second optical device.

In this embodiment, similar to that in the aforementioned embodiments, the process of forming the second optical device layer in the silicon nitride material layer is similar to the process of forming the first optical device in the top silicon layer, and it is not repeated here. In this embodiment, optical devices in the first optical device layer include a first coupler, a first beam splitter, a first phase shifter and a first optical antenna. In addition to the first optical device layer, the optical device structure layer further includes the aforementioned second optical device layer. The optical devices in the second optical device layer include a second coupler, a second beam splitter, a second phase shifter and a second optical antenna. When the first optical devices in the first optical device layer are combined with the second optical devices in the second optical device layer, at least part of a third coupler, a third beam splitter, a third phase shifter and a third optical antenna are formed by coupling.

In order to space the first optical device layer from the second optical device layer, before the protection layer is formed, the silicon dioxide material may be deposited on the SOI substrate on which the first optical device layer is formed to form the first spacer layer, and then the silicon nitride material may be deposited on the first spacer layer to form the silicon nitride material layer, and the second optical device layer may be formed in the silicon nitride material layer. The formation method of the first spacer layer is similar to that of the protection layer, and the forming method of the second optical device layer is similar to that of the first optical device layer, and it is not repeated here.

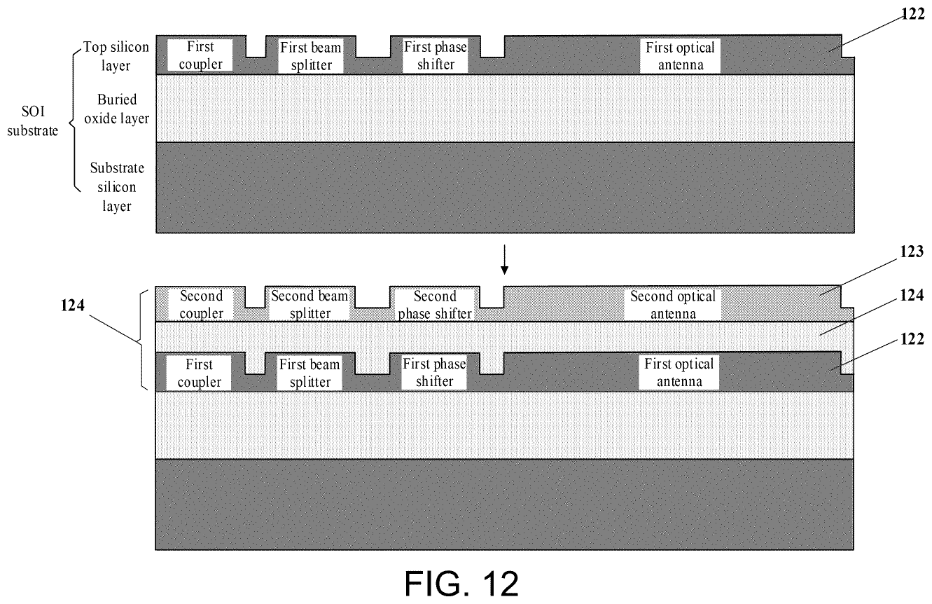

For example, when preparing an optical chip, an optical device layer may be first formed on an SOI substrate, as shown in FIG. 12, which shows a substrate, i.e., an SOI substrate, which includes a top silicon layer, a buried oxide layer and a substrate silicon layer. First, first optical devices are fabricated on the top silicon layer to obtain a first optical device layer 122. The first optical devices include a first coupler, a first beam splitter, a first phase shifter and a first optical antenna, and may further include a first optical waveguide between the first coupler and the first beam splitter.

Silicon dioxide is grown above the top silicon layer in the SOI substrate for the first time to form a spacer layer, i.e., a first spacer layer 124, for protecting the first optical devices, and a silicon nitride layer is grown on the silicon dioxide grown for the first time, and second optical devices are fabricated on the silicon nitride layer to obtain a second optical device layer 123, the second optical devices include a second coupler, a second beam splitter, a second phase shifter and a second optical antenna, and may further include a second optical waveguide between the second coupler and the second beam splitter. The optical devices on the silicon nitride layer may be combined with the optical devices on the top silicon layer, and optical devices (third optical devices integrated on the optical chip) such as a third coupler, a third beam splitter, a third phase shifter and a third optical antenna may be formed.

A thickness of the first spacer is adjustable and this may be achieved by deposition and planarization of an oxide, for example. The planarization here may be implemented by a CMP (Chemical Mechanical Polishing) process, so as to meet requirements on the different thickness of the first spacer layer and the requirements on the flatness of the upper surface of the first spacer layer.

According to an embodiment provided in the present application, the optical device structure layer includes a plurality of optical device layers made of different materials, the advantages of different materials may be combined to improve the reliability of light beam propagation; the spacer layer is disposed between adjacent optical device layers to space the adjacent optical device layers, which may reduce the difficulty of preparing the optical device layers.

As a solution, the forming the optical device structure layer on the top silicon layer of the SOI substrate further includes: before forming the protection layer, depositing a silicon dioxide material on the SOI substrate on which the second optical device layer is formed to form a second spacer layer; and forming a reflection layer on the second spacer layer.

Similar to that in the aforementioned embodiments, a reflection layer may be added in the optical device structure layer, and the reflection layer includes a reflection structure used to reflect light beams emitted from at least some optical antennas of the first optical antenna, the second optical antenna and the third optical antenna, so that the light beams penetrate the SOI substrate and are emitted to a space, that is, the light beams is emitted upwards to a detection space. Meanwhile, in order to space the reflection layer from the second optical device layer, a second spacer layer may be formed between the reflection layer and the second optical device layer. The forming method of the second spacer layer is the same as or similar to that of the first spacer layer, and it is not repeated here.

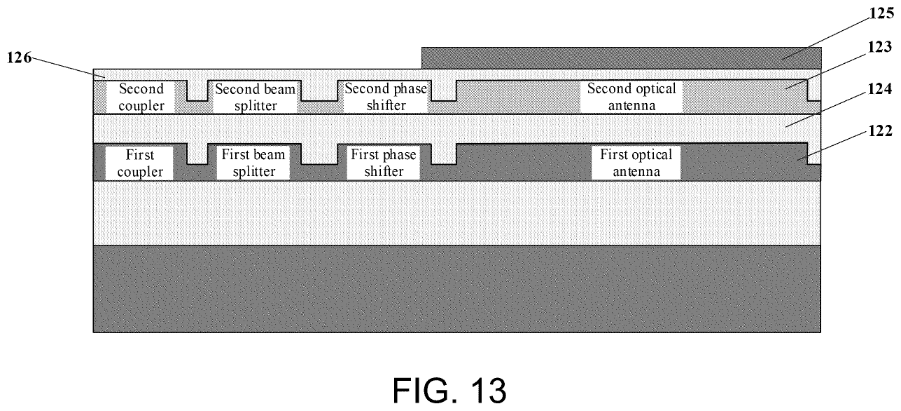

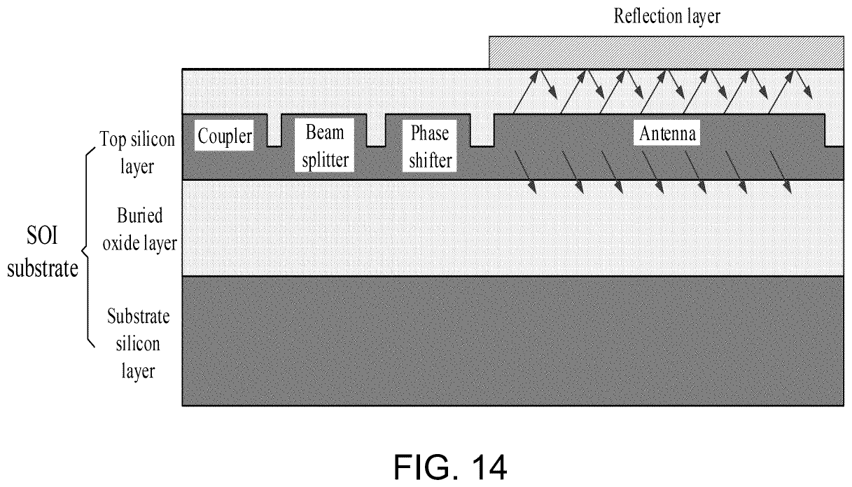

For example, silicon dioxide is grown on the silicon nitride layer (the second optical device layer 123) for a second time to form a spacer layer, i.e., the second spacer layer 126, for protecting the second optical devices and the third optical devices. A metal material is grown or deposited on the silicon dioxide grown for the second time (to form a metal material layer, which may be a first metal material layer), or a dielectric film is evaporated thereon, or a reflective grating is fabricated thereon to form the reflection layer 125, as shown in FIG. 13. An upward-emitted signal light may be reflected downward by the reflection layer 125, and then passes through the SOI substrate and then is emitted into the space. Here, the signal light that is reflected downward and passes through the SOI substrate and is emitted into the space, may be emitted into the detection space after only passing through the remaining part of the SOI substrate. As shown in FIG. 14, the optical devices in FIG. 14 may be the corresponding optical devices in the first optical device layer, the second optical device layer and the third optical device layer, where the substrate silicon layer of the SOI substrate will be removed.

An upward-emitted light beam may be reflected downward by the reflection layer 125, then passes through the SOI substrate and is emitted into detection space. Here, while the light beam which is reflected downward, passes through the SOI substrate and then is emitted into the space, it only needs to pass through the remaining part of the SOI substrate. When the reflection layer is prepared, the heat isolation substrate is not fixed on the protection layer, and the direction of the device is reversed. In actual use, the heat isolation substrate is located below the protection layer, and at this time, the emitted light beam is reflected upward into the detection space. The situation, in which the light beam emitted from the optical device layer is emitted upwards to the detection space, means that the light beam emitted from the optical device structure layer is emitted upwards to the detection space according to the placement manner that the optical device structure layer is on the top and the reflection layer is on the bottom. When the optical chip is prepared, the situation, in which the upward emitted signal light is reflected downward by the reflection layer, then passes through the SOI substrate and then is emitted into the space, means that the upward emitted signal light is reflected downward by the reflection layer, then passes through the SOI substrate and then is emitted to the detection space according to the placing manner that the optical device structure layer is on the bottom and the reflection layer is on the top.

According to an embodiment provided in the present application, before the protection layer is formed, a reflection layer is formed, so that light emitted from the optical antenna may only be emitted from the other side thereof, the emission efficiency of the optical antenna is improved, the light loss is reduced, and the utilization efficiency of input light is improved. Before the reflection layer is formed, a spacer layer is formed, so that the reflection layer may be spaced from the optical device structure layer, the difficulty of preparing the optical chip is reduced.

As a solution, the forming the optical device structure layer on the top silicon layer of the SOI substrate further includes:
before forming the protection layer, depositing a silicon dioxide material on the SOI substrate on which the reflection layer is formed to form a third spacer layer; and
forming a metal material layer (the formed metal material layer may be a second metal material layer) on the third spacer layer, and forming an optical correction structure through a patterning process, where the optical correction structure is used to change part or whole refractive index of at least some optical antennas of the first optical antenna, the second optical antenna and the third optical antenna.

In order to improve the light beam emission capability of the optical antennas, an optical correction structure may be formed based on the positions of the optical antennas (for example, the first optical antenna, the second optical antenna, the third optical antenna, etc.) in the optical device structure layer, here, the optical correction structure is used to change part or whole refractive index of at least some optical antennas of the first optical antenna, the second optical antenna and the third optical antenna.

The optical correction structure may be formed by a patterning process. Here, the patterning process refers to a process of transferring designed patterns, structures and circuit patterns to the surface of the chip through process steps such as photolithography, etching, deposition (similar to those in the aforementioned embodiments). The accuracy and stability of the patterning process have an important influence on the performance and stability of the chip.

In order to protect the reflection layer, before the optical correction structure is formed, a silicon dioxide material may be deposited on the SOI substrate on which the reflection layer is formed to form a third spacer layer to protect the reflection layer. The forming method of the third spacer layer is the same as or similar to those of the first spacer layer and the second spacer layer, and it is not repeated here.

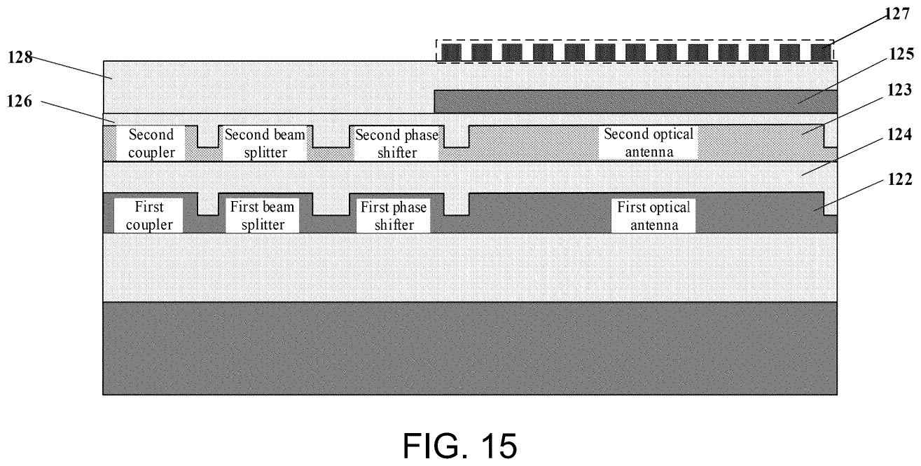

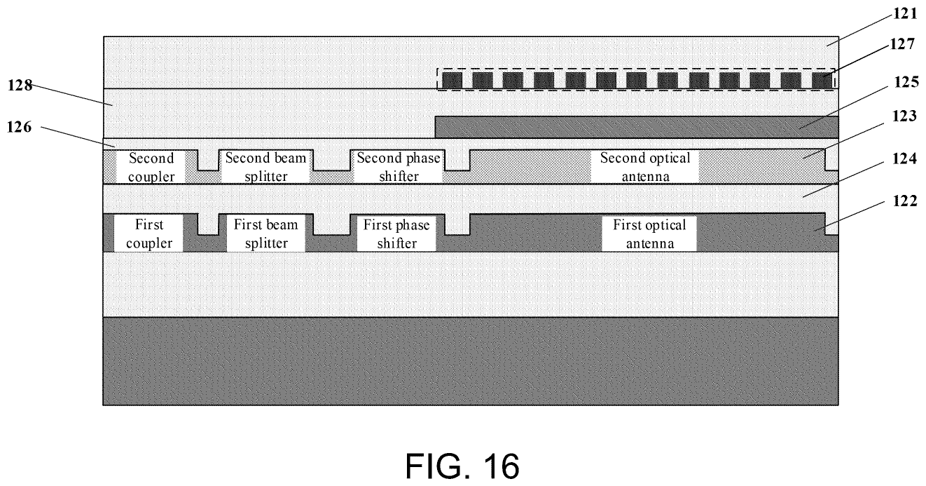

For example, as shown in FIG. 15, silicon dioxide is grown above the reflection layer 125 for a third time to form a spacer layer, i.e., a third spacer layer 128, for protecting the reflection layer 125. Metal is grown or deposited on the silicon dioxide grown for the third time to fabricate one or more thermal resistors, PZT (Lead Zirconate Titanate Thin Film, i.e., Piezoelectric Ceramic) or a sound field device, etc., to form an optical correction structure 127 (an optical correction device), which may adjust the refractive index of different areas of the first optical antenna, the second optical antenna and the third optical antenna. In addition, silicon dioxide may be grown above the optical correction structure 127 for a fourth time to form a protection layer 121 for protecting the optical correction structure 127, as shown in FIG. 16.

In an implementation, a plurality of through holes may be formed in the silicon dioxide grown for four times by etching, and the through holes extend to the first optical device, the second optical device, the third optical device and the optical correction device as needed, respectively, and a metal is grown or deposited therein to form electrical connection.

In an implementation, a metal is grown or deposited on the silicon dioxide grown for the fourth time, and the metal is patterned to form a first metal wiring layer. By etching, a plurality of back holes are formed on a back surface of the SOI substrate from which the substrate silicon layer is completely or partially removed, and the back holes extend to the first metal wiring layer as needed, respectively, a metal is grown or deposited therein, and an electrode pad is formed at the top of the back holes, so that electrical connection to the outside may be made by wire bonding or flip chip bonding. As shown in FIG. 10, a pad electrode corresponding to the phase shifter is formed, and an operating voltage is provided to the phase shifter through this pad electrode. Silicon dioxide is grown on the first metal wiring layer for a fifth time for protecting the first metal wiring layer. Here, the overall thickness of silicon dioxide grown for the first time, the second time, the third time, the fourth time and the fifth time is 0.2 μm to 20 μm.

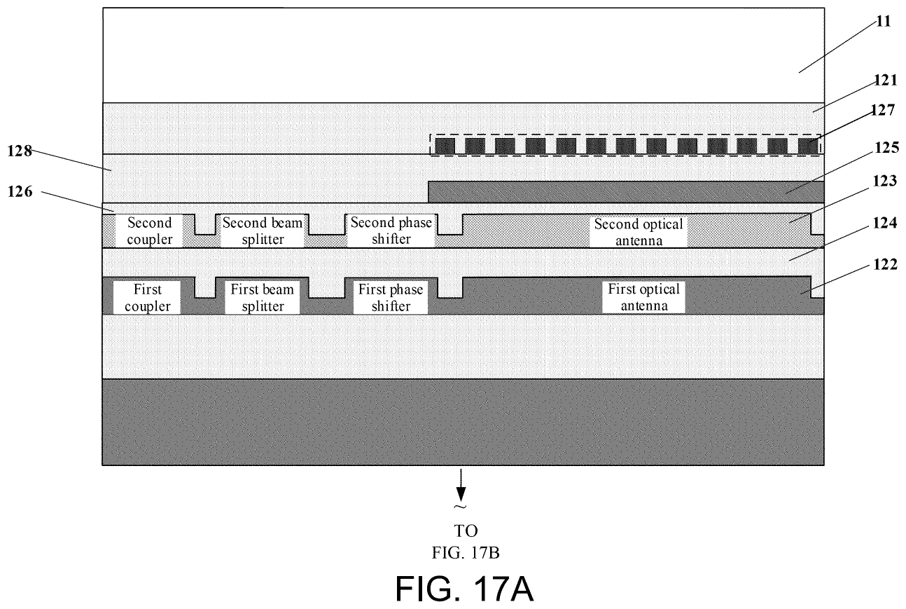

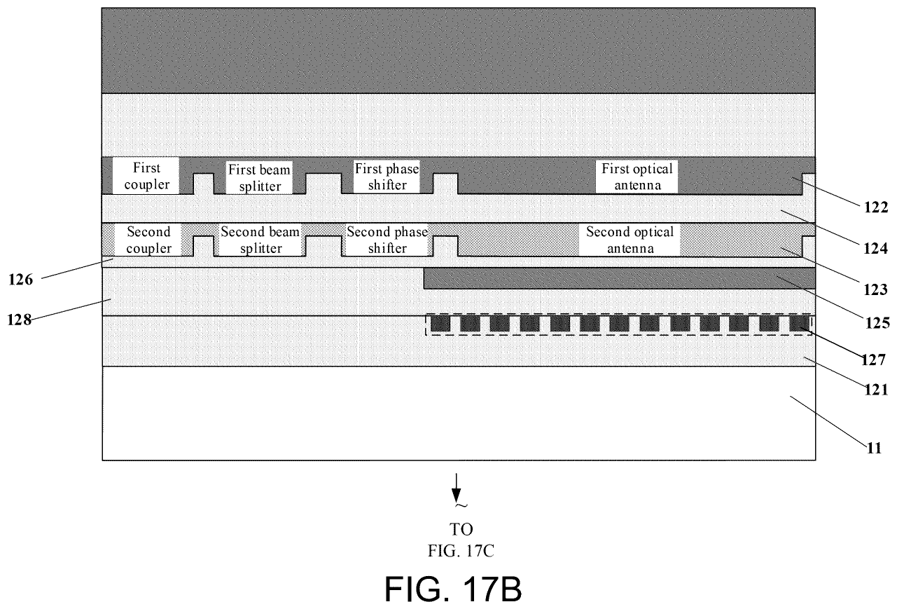

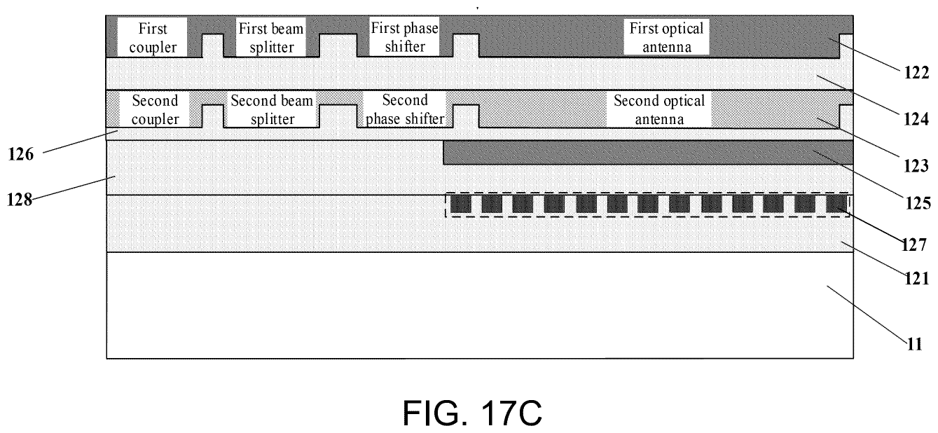

Then, a heat isolation substrate 11 may be provided and fixed to the surface of silicon dioxide grown for the fifth time, and fixing the heat isolation substrate 11 may be achieved by bonding the heat isolation substrate 11 to the surface of silicon dioxide grown for the fifth time; the device is then turned over, and the substrate silicon layer in the SOI substrate is completely or partially removed, for example, the bottom silicon layer is removed, as shown in FIG. 17A, FIG. 17B, FIG. 17C.

If there is less metal wiring, only the first metal wiring layer may be formed; if there is a lot of metal wiring, one or more additional metal wiring layers need to be added. For example, a metal is grown or deposited on the back surface of SOI substrate from which the substrate silicon layer is completely or partially removed, and is patterned to form a second metal wiring layer; silicon dioxide is grown on the second metal wiring layer for a sixth time for protecting the second metal wiring layer, and in turn, until the formed metal wiring layers meet the requirements of metal wiring. Therefore, the preparation of the optical chip is completed.

According to the embodiments provided in the present application, the refractive index of the optical antenna may be changed by heating the optical antennas through the optical correction structure, so that the direction of the emitted light beam corresponding to the antenna is changed, and the spot alignment is achieved. The optical correction structure may further include a plurality of groups of local heating structures, and each local heating structure may be independently controlled for heating, so as to achieve accurate control of the optical antenna to be heated, compensate the inconsistency in the aperture of the optical antenna caused by the process, thereby improving the spot quality of emitted light beams. Each group of local heating structures are evenly distributed above the corresponding optical antenna, and the specific number may be set as required, and it is not limited in this embodiment.

It should be noted that for the sake of simple description, the aforementioned method embodiments are expressed as combinations of a series of actions, but those of skill in the art should know that the present application is not limited to the described sequence of actions, because according to the present application, some steps may be performed in other sequences or at the same time. Secondly, those of skill in the art should also know that the embodiments described in the specification are all embodiments, and the actions and modules involved are not necessary for the present application.

When integrated units in the above embodiments are implemented in the form of software functional units and sold or used as independent products, they may be stored in the above computer-readable storage media. Based on such understanding, the technical solutions of the present application in essential or the part that contributes to the related technology, or all or part of the technical solutions may be embodied in the form of software products, and these computer software products are stored in storage media and include several instructions to make one or more computer devices (which may be personal computers, servers or network devices) perform all or part of the steps of the methods described in the embodiments of the present application.

In the above embodiments of the present application, the description of each embodiment has its own emphasis. For the part not detailed in a certain embodiment, please refer to the relevant description of other embodiments.

Units described as separate parts may or may not be physically separated, and parts displayed as units may or may not be physical units, that is, they may be located in one place or distributed to a plurality of network units. Part or all of the units may be selected according to actual needs to achieve the purposes of the embodiments.

In addition, the functional units in the embodiments of the present application may be integrated into one processing unit, or the units may exist separately physically, or at least two units may be integrated into one unit. The above integrated units may be implemented in the form of hardware, and may also be implemented in the form of software functional units.

The above are only embodiments of the present application, and it should be pointed out that for those of ordinary skill in the art, several improvements and modifications may be made without departing from the principles of the present application, and these improvements and modifications should also be regarded as the protection scope of the present application.

What is claimed is:

1. An optical chip, comprising a heat isolation substrate and an optical device structure layer formed based on a top silicon layer in an SOI substrate and located above the heat isolation substrate; wherein
the heat isolation substrate is in a single-layer material structure or a laminated structure including a plurality of material layers, and the heat isolation substrate comprises at least one material layer formed of a material with a thermal conductivity less than 100 W/(m·K);
the optical device structure layer formed based on the top silicon layer in the SOI substrate sequentially comprises:
a protection layer located above the heat isolation substrate and fixedly connected with the heat isolation substrate; and
a first optical device layer located on the protection layer and including at least one first optical device,
wherein a light beam emitted through the optical device structure layer is emitted upwards to a detection space.

2. The optical chip according to claim 1, wherein a thickness of the heat isolation substrate is greater than 50 μm.

3. The optical chip according to claim 2, wherein when the heat isolation substrate is in the laminated structure, a thickness of the material layer formed of the material with a thermal conductivity less than 100 W/(m·K) is greater than or equal to 10 μm.

4. The optical chip according to claim 1, wherein a material of the heat isolation substrate comprises one or more of silicon dioxide, quartz, glass, and plastic.

5. The optical chip according to claim 1, wherein the first optical device layer is formed of a silicon material; and the optical device structure layer further comprises:
a second optical device layer located between the first optical device layer and the protection layer, formed of a silicon nitride material and including at least one second optical device; and
a first spacer layer located between the first optical device layer and the second optical device layer for spacing the first optical device layer and the second optical device layer.

6. The optical chip according to claim 5, wherein
first optical devices in the first optical device layer comprise a first coupler, a first beam splitter, a first phase shifter, and a first optical antenna; and
second optical devices in the second optical device layer comprise a second coupler, a second beam splitter, a second phase shifter, and a second optical antenna,
wherein when the first optical devices in the first optical device layer are combined with the second optical devices in the second optical device layer, at least part of a third coupler, a third beam splitter, a third phase shifter and a third optical antenna are formed by coupling.

7. The optical chip according to claim 6, wherein the optical device structure layer further comprises:
a reflection layer located between the second optical device layer and the protection layer and comprising a reflection structure, wherein the reflection structure is configured to upwardly reflect light beams emitted from at least some optical antennas of the first optical antenna, the second optical antenna, and the third optical antenna; and
a second spacer layer located between the reflection layer and the second optical device layer for spacing the reflection layer and the second optical device structure.

8. The optical chip according to claim 7, wherein a projection of the reflection layer in a vertical direction partially or completely overlaps with a projection of any one or more optical antennas of the first optical antenna, the second optical antenna, and the third optical antenna in the vertical direction.

9. The optical chip according to claim 7, wherein the optical device structure layer further comprises:
an optical correction structure located between the reflection layer and the protection layer, for heating any one or more optical antennas of the first optical antenna, the second optical antenna, and the third optical antenna to change part or whole refractive index of any one or more optical antennas of the first optical antenna, the second optical antenna, and the third optical antenna.

10. The optical chip according to claim 9, wherein the optical correction structure comprises a plurality of groups of heating structures, and different groups of heating structures in the plurality of groups of heating structures are configured to heat different parts of any one or more optical antennas of the first optical antenna, the second optical antenna, and the third optical antenna.

11. The optical chip according to claim 10, wherein heating parameters of different groups of heating structures among the plurality of groups of heating structures are the same; or, heating parameters of different groups of heating structures among the plurality of groups of heating structures are different.

12. A preparation method for an optical chip, comprising:
providing an SOI substrate;
forming an optical device structure layer on a top silicon layer of the SOI substrate, comprising: forming a first optical device layer in the top silicon layer of the SOI substrate, wherein the first optical device layer includes at least one first optical device; and depositing a silicon dioxide material on the SOI substrate, where the first optical device layer is formed, to form a protection layer; and
providing a heat isolation substrate and fixing the heat isolation substrate on the protection layer, and then removing all or part of a substrate silicon layer in the SOI substrate,
wherein the heat isolation substrate is in a single-layer material structure or a laminated structure including a plurality of material layers, and the heat isolation substrate comprises at least one material layer formed of a material with a thermal conductivity less than 100 W/(m·K); and a light beam emitted through the optical device structure layer is emitted upwards to a detection space.

13. The preparation method according to claim 12, wherein a thickness of the heat isolation substrate is greater than 100 μm; and
when the heat isolation substrate is in the laminated structure, a thickness of the material layer formed of the material with a thermal conductivity less than 100 W/(m·K) is greater than or equal to 10 μm.

14. The preparation method according to claim 12, wherein the heat isolation substrate is formed of one or more materials of silicon dioxide, quartz, glass, and plastic.

15. The preparation method according to claim 12, wherein the forming the optical device structure layer on the top silicon layer of the SOI substrate further comprises:
before forming the protection layer, depositing a silicon dioxide material on the SOI substrate, where the first optical device layer is formed, to form a first spacer layer; and
forming a silicon nitride material layer on the first spacer layer, and forming a second optical device layer in the silicon nitride material layer, wherein the second optical device layer comprises at least one second optical device,
wherein first optical devices in the first optical device layer comprise a first coupler, a first beam splitter, a first phase shifter, and a first optical antenna, and second optical devices in the second optical device layer comprise a second coupler, a second beam splitter, a second phase shifter, and a second optical antenna; and when the first optical devices in the first optical device layer are combined with the second optical devices in the second optical device layer, at least part of a third coupler, a third beam splitter, a third phase shifter and a third optical antenna are formed by coupling.

16. The preparation method according to claim 15, wherein the forming the optical device structure layer on the top silicon layer of the SOI substrate further comprises:
before forming the protection layer, depositing a silicon dioxide material on the SOI substrate where the second optical device layer is formed to form a second spacer layer; and
forming a reflection layer on the second spacer layer, wherein the reflection layer comprises a reflection structure, and the reflection structure is configured to reflect light beams emitted from at least some optical antennas of the first optical antenna, the second optical antenna, and the third optical antenna, so that the light beams penetrate the SOI substrate and are emitted into a detection space.

17. The preparation method according to claim 16, wherein the forming the optical device structure layer on the top silicon layer of the SOI substrate further comprises:
before forming the protection layer, depositing a silicon dioxide material on the SOI substrate, where the reflection layer is formed, to form a third spacer layer; and
forming a metal material layer on the third spacer layer, and forming an optical correction structure through a patterning process, wherein the optical correction structure is configured to change part or whole refractive index of any one or more of the first optical antenna, the second optical antenna, and the third optical antenna.
